(19) United States
(12) Patent Application Publication
(10) Pub. No.: US 2008/0192144 A1
(43) Pub. Date: Aug. 14, 2008

(54) System and Method for Multi-picture Display

(75) Inventor: Gaofeng Li, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/015,419

(22) Filed: Jan. 16, 2008

(30) Foreign Application Priority Data
Feb. 8, 2007 (CN) 200710063747.1

(51) Int. Cl. H04N 5/445

(52) U.S. Cl. 348/564; 348/E05.099

(57) ABSTRACT

Techniques for displaying multiple videos are disclosed. According to one aspect, video from a sub-channel is displayed together with other videos, where the video from the sub-channel is displayed in a resolution similar to the original. As a result, only an area of interest in the video from the sub-channel can be viewed. The benefits and advantages include that a viewer can still clearly watch the area of interest in the video from the sub-channel while watching a main channel or other channels.

### BACKGROUND OF THE INVENTION

1. Field of the Invention

The present invention relates to techniques for image processing, more particularly to a system and a method for multi-picture display.

2. Description of Related Art

There are mainly two conventional ways to implement a multi-picture display function in a television device, one is picture in picture, the other is picture by picture. FIG. 1 is an exemplary view illustrating two pictures being shown in the picture-in-picture fashion. FIG. 2 is an exemplary view illustrating the two pictures being shown in the picture-by-picture fashion. A method for the conventional multi-picture display includes that multiple tuners are provided on a television device for receiving input pictures from multiple channels and sending the input pictures from the multiple channels to a digital image processing module, the digital image processing module composes whole pictures from the channels predetermined by users into a single picture, and then the composed single picture is outputted to a display unit.

In the conventional multi-picture display, several whole pictures are being displayed on a display screen of the television simultaneously. However, the user may be only interested in a partial area of a whole picture instead of the whole picture in some applications. Furthermore, due to several whole pictures being displayed on the display screen simultaneously, a display area of one or more pictures in the display screen is caused to be too small to discern the interested contents for the user.

Thus, the improved techniques for multi-picture display are needed to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for displaying multiple videos from different channels. According to one aspect of the present invention, one channel is selected as a main channel and another channel is selected as a sub-channel. While receiving both videos or input pictures from the main channel and the sub-channel, a display area of the input picture of the sub-channel is determined. The display area of the input picture of the sub-channel is superimposed onto the input picture of the main-channel to form one single composed picture.

According to another aspect of the present invention, a number of channels are selected as a group of sub-channels. A display area for each of the selected channels is determined. The display areas of the selected channels are composed into one single composed picture for display.

One of the features, benefits and advantages in the present invention is to provide techniques for displaying multiple videos at the same time, where pictures from the sub-channels are displayed in resolution substantially close to the original so that an area of interest therein can be viewed clearly.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is an exemplary view illustrating a conventional multi-picture display function in a picture in picture way;

FIG. 2 is an exemplary view illustrating a conventional multi-picture display function in a picture by picture way;

FIG. 3 is a block diagram showing a television device according to one embodiment of the present invention;

FIG. 4 is a flowchart showing a method for multi-picture display according to one embodiment of the present invention;

FIG. 5A is an exemplary effect view illustrating a multi-picture display of the method according to a first embodiment of the present invention;

FIG. 5B is an exemplary effect view illustrating a multi-picture display of the method according to a second embodiment of the present invention; and

FIG. 6 is a block diagram showing a system for multi-picture display according to one embodiment of the present invention.

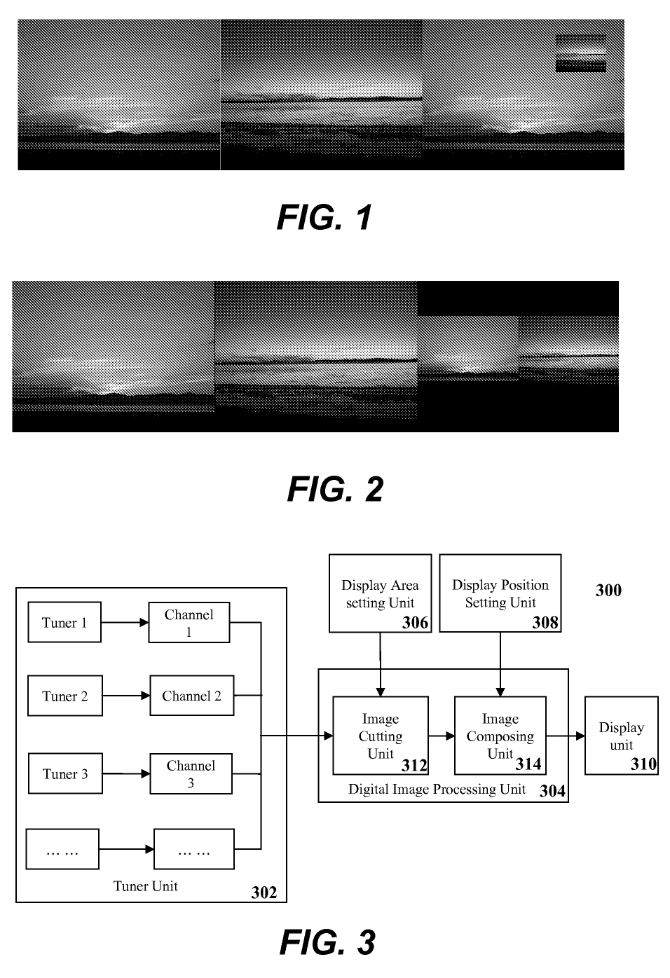

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 2-7. However, those skilled in the art will readily appreciate that the detailed description given herein with respect to these figures is for explanatory purposes only as the invention extends beyond these limited embodiments.

A method for multi-picture display proposed according to one embodiment of the present invention comprises: determining one channel as a main channel and another channel as a sub-channel, receiving an input picture of the main channel and an input picture of the sub-channel, selecting a display area of the input picture of the sub-channel, cutting the display area of the input picture of the sub-channel, composing the display area of the input picture of the sub-channel and the input picture of the main channel into one single picture with the display area of the input picture of the sub-channel superimposed on the input picture of the main channel. In the composed single picture, the display area of the input picture of the sub-channel retains an original resolution thereof. Thereby, a user can not only discern the input picture of the main channel but also can discern the display area of the input picture of the sub-channel.

On the other hand, the method for multi-picture display proposed according to another embodiment of the present invention comprises: determining one channel as a first sub-channel and another channel as a second sub-channel, receiving an input picture of the first sub-channel and an input picture of the second sub-channel, selecting a display area of the input picture of the playing sub-channel and a display area of the input picture of the second sub-channel, cutting the display areas of the input pictures of the first and second sub-channels; composing the display areas of the input pictures of the first and second sub-channels into one single picture including the display areas of the input pictures of the first and second sub-channels arranged side by side. In the composed single picture, the display areas of the input pictures of the first and second sub-channels retain an original resolution thereof. Thereby, the user can not only discern the input picture of the first sub-channel but also can discern the display area of the input picture of the sub-channel.

One embodiment of the present invention may be advantageously applied in a television device. FIG. 3 is a block diagram showing the television device according to one embodiment of the present invention. The television device comprises a tuner unit 302, a digital image processing unit 304, a display area setting unit 306, a display position setting unit 308 and a display unit 310. The digital image processing unit 304 comprises an image cutting unit 312 and an image composing unit 314.

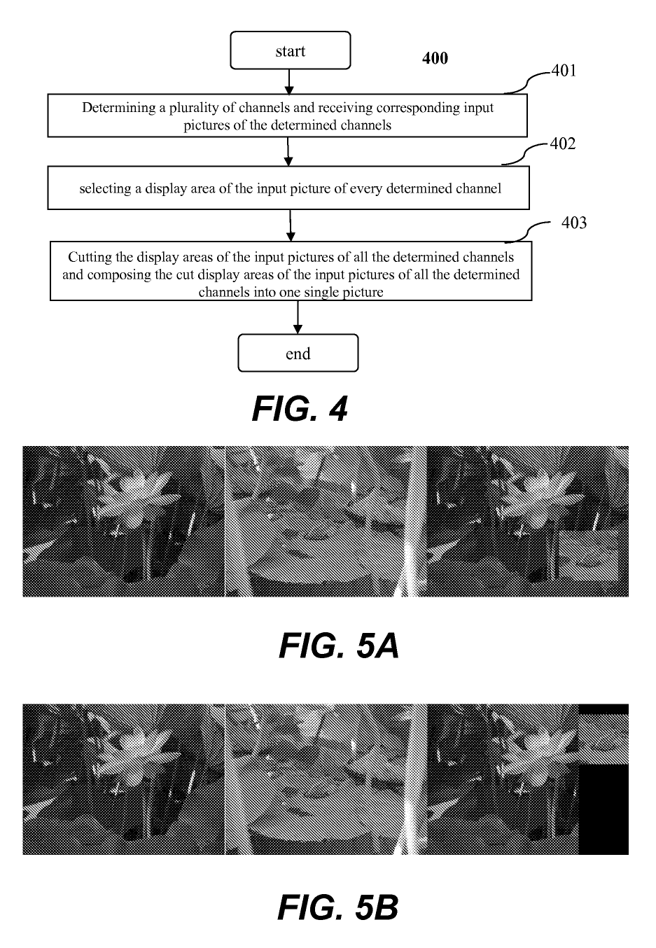

FIG. 4 is a flowchart or process 400 showing the method for multi-picture display according to one embodiment of the present invention. The process 400 may be understood in conjunction with FIG. 3. At 401, the television device determines a plurality of channels and receives corresponding input pictures of the respective channels. The tuner unit 302 comprises a plurality of tuners, each of which is configured or tuned for locking one television channel and receiving the input picture of the locked channel. If the television has the N tuners, the television is able to lock N number channels at the same time. A user can optionally select the channels according to his interest. The received pictures of the channels selected are forwarded to the digital image processing unit 304.

In one case, the television device regards one of the determined channels as the main-channel being played and regards the other determined channels as the sub-channels being played. In another case, the television device regards all the determined channels as the sub-channels being played. At 402, a display area of the input picture of every determined channel is selected by the display area setting unit 306. The user can optionally select a display area of the input picture of every determined channel by the display area setting unit 308. If one determined channel is regarded as the main channel, the whole input picture of the main-channel is defaulted as the display area of the input picture of this determined channel. If one determined channel is regarded as a sub-channel, a partial interested area of the input picture of the playing sub-channel is selected as a display area of the input picture of this determined channel.

For example, provided that the user wants to watch a partial area of the input picture of a china central TV-5 (CCTV-5) channel, such as a score display area of a NBA basketball game, the score display area can be selected as the display area of the input picture of the CCTV-5 channel.

In operation, the display area setting unit 308 needs to determine a position parameter of the selected display area of the input picture of every sub-channel and send the position parameter to the digital image processing unit 304 for storage. The position parameter is provided for uniquely identifying the selected display area of the input picture of every sub-channel. For example, if the user turns into a channel 3 and selects one rectangular area in the input picture of the channel 3 as the display area, a coordinate value of a left lower corner and a coordinate value of a right lower corner of the rectangular area may be saved as the position parameter of the channel 3. For another example, if the user turns into a channel 4 and selects one circular area in the input picture of the channel 4 as the display area, a coordinate value of a centre of the circular area and a radius value of the circular area may be saved as the position parameters of the channel 4.

At 403, the image cutting unit 312 cuts the display areas of the input pictures of all the determined channels and the image composing unit 304 composes the cut display areas of the input pictures of all the determined channels into one single picture.

In the case of one of the determined channels being regarded as the main channel and the other determined channels being regarded as the sub-channels, the operation 403 is specifically performed by: cutting the display areas of the input pictures of the sub-channels; composing the display areas of the input pictures of the sub-channels and the input picture of the main channel into one single picture with the display areas of the input pictures of the sub-channels covered on the input picture of the main-channel. In the composed single picture, the display area of the input picture of every playing sub-channel retains an original size thereof. Thereby, the user not only can discern the input picture of the playing main-channel but also can discern the display area of the input picture of the playing sub-channel.

Specifically, the image cutting unit 312 gets pixels in the display area of the input picture of every sub-channel according to corresponding position parameter and outputs the pixels in the display area of the input picture of every sub-channel to the image composing unit 304. Then, the image composing unit 304 covers the pixels in the display area of the input picture of every sub-channel on the input picture of the main channel at a display position corresponding to the position parameter of the corresponding playing sub-channel. Before the composing operation, the display position setting unit 308 may be provided for adjusting the display position of the display area of the input picture of every sub-channel on the input picture of the main-channel. It should be noted that the user can optionally adjust the display position of the display area of the input picture of every determined channel on the input picture of the main-channel by the display position 308 setting unit at anytime.

In the case of all the determined channels regarded as the sub-channels, the operation 403 is specifically performed by: cutting the display areas of the input pictures of the sub-channels; composing the display areas of the input pictures of the sub-channels into one single picture with the display areas of the input pictures of the sub-channels arranged side by side. In the composed single picture, the display area of the input picture of every sub-channel retains an original size thereof. Thereby, the user not only can discern the input picture of the first playing sub-channel but also can discern the display area of the input picture of the playing sub-channel.

Specifically, the image cutting unit 312 gets pixels in the display area of the input picture of every playing sub-channel according to corresponding position parameter and outputs the pixels in the display area of the input picture of every sub-channel to the image composing unit 314. The image composing unit 314 arranges the pixels in the display areas of the input pictures of the sub-channels side by side into one single picture. A display position of the display area of the input picture of every sub-channel on the composed single picture refers to the corresponding position parameter of the display area of the input picture of every sub-channel. Before the composing operation, the display position setting unit 308 may be provided for adjusting a display position of the display area of the input picture of every playing sub-channel.

In one embodiment, when watching channel 2, the user may also want to watch a partial interested area of channel 1. In operation, the user determines the channel 2 as the main channel and the channel 1 as the sub-channel. Then, the partial interested area of the input picture of the channel 1 is selected as a display area of the channel 1. Simultaneously, the position parameter of the display area of the channel 1 is determined and saved. Subsequently, the display position setting unit 306 positions the display area of the channel 1 on the input picture of the channel 2 in a suitable position adjustable by the user. Finally, the image cutting unit 314 cuts the display area of the input picture of the channel 1 and the image composing unit 304 covers the display area of the input picture of the channel 1 on the input picture of the channel 2 in the predetermined position.

In another embodiment, the user wants to watch a partial interested area of the channel 1 and a partial interested area of the channel 2 at the same time. In operation, the user determines the channel 1 as the first sub-channel and the channel 2 as the second sub-channel. Then, the partial interested area of the input picture of the channel 1 is selected as the display area of the first sub-channel and the position parameter of the display area of the first sub-channel is determined and saved. By the same way, the interested partial area of the input picture of the channel 2 is selected as the display area of the second sub-channel and then the position parameter of the display area of the second sub-channel is obtained and saved. Subsequently, the display position setting unit 308 puts the display areas of the channels 1 and 2 on a composed single picture in suitable display positions. Finally, the image cutting unit 312 cuts the display areas of the input pictures of the channel 1 and 2 and the image composing unit composes the display area of the input picture of the channel 1 and the display area of the input picture of the channel 2 side by side into one single picture.

FIG. 5A is an exemplary view illustrating a multi-picture display of the method according to one embodiment of the present invention. FIG. 5A consists of three pictures, a left picture is an input picture of the main channel, a middle picture is an input picture of the playing sub-channel and a right picture is a single picture composed by the middle picture and the left picture. “A frog on a lotus leaf” of the middle picture is selected as the display area of the playing sub-channel.

FIG. 5B is an exemplary view illustrating a multi-picture display of the method according to another embodiment of the present invention. FIG. 5B consists of three pictures, a left picture is an input picture of the first playing sub-channel, a middle picture is an input picture of the second playing sub-channel and a right picture is a single picture composed by the middle picture and the left picture. “A frog on a lotus leaf” of the middle picture is selected as the display area of the second playing sub-channel. A left side area of the left picture is selected as the display area of the first playing sub-channel.

It should be noted that the method for multi-picture display can be applied not only in the television device, but also in other picture display devices such as a film play device or a computer display device.

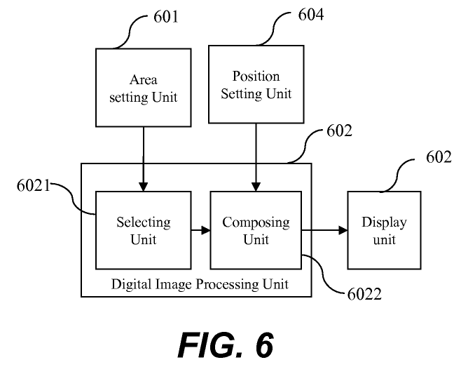

To further understand the present invention, a system for multi-picture display according to one embodiment of the present invention is provided in FIG. 6 that shows a system for multi-picture display according to one embodiment of the present invention. In FIG. 6, the system comprises a display area setting unit 601, a digital image processing unit 602, a display position setting unit 604 and a display unit 603. The system determines a plurality of channels and receives corresponding input pictures of the determined channels firstly. The display area setting unit 601 is configured for selecting a display area of an input picture of every determined channel. The digital image processing unit 602 is configured for cutting the display areas of the input pictures of all the determined channels and composing the cut display areas of the input pictures of all the determined channels into one single picture. The display unit 603 is configured for displaying the composed single picture for users.

The display area setting unit 601 is also configured for obtaining a position parameter of the display area of the input picture of every determined channel. The digital image processing unit 602 comprises an image cutting unit 6021 and an image composing unit 6022. The image cutting unit 6021 is configured for cutting the display area of the input picture of every determined channel according to the obtained position parameter. The image composing unit composes the cut display areas of the input pictures of all the determined channels into one single picture.

In one case, the system regards one of the determined channels as the playing main-channel and regards the other determined channels as the playing sub-channels. The image cutting unit gets pixels in the display area of the input picture of every playing sub-channel according to the obtained position parameter and outputs the pixels in the display area of the input picture of every playing sub-channel to the image composing unit. Then, the image composing unit replaces a part of pixels of the input picture of the playing main-channel by the pixels in the display area of the input picture of every playing sub-channel. The display position setting unit is configured for adjusting a display position of the display area of the input picture of every playing sub-channel on the input picture of the playing main-channel.

In another case, the system regards all the determined channels as the playing sub-channels. The image cutting unit gets pixels in the display area of the input picture of every playing sub-channel according to the obtained position parameter and outputs the pixels in the display area of the input picture of every playing sub-channel to the image composing unit. The image composing unit arranges the pixels in the display areas of the input pictures of the playing sub-channels side by side into one single picture. The display position setting unit is configured for adjusting a display position of the display area of the input picture of every playing sub-channel.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for multi-picture display, the method comprising:
determining one channel as a main channel and another channel as a sub-channel;
receiving an input picture from the playing main channel and an input picture from the playing sub-channel;
selecting a display area of the input picture of the sub-channel;
determining the display area of the input picture of the sub-channel; and
composing the display area of the input picture of the sub-channel with the input picture of the main-channel to form one single composed picture with the display area of the input picture of the sub-channel superimposed on the input picture of the main-channel.

2. The method according to claim 1, wherein the display area of the input picture of the sub-channel in the single composed single picture retains an original resolution thereof so that an area of interest in the input picture of the sub-channel can be seen clearly while watching the main channel.

3. The method according to claim 2, further comprising:
displaying the single composed picture on a display screen.

4. The method according to claim 1, wherein the display area of the input picture of the sub-channel is a partial area of the input picture of the sub-channel.

5. The method according to claim 1, wherein when the selecting the display area of the input picture of the sub-channel is performed, a position parameter of the selected display area of the input picture of the playing sub-channel is obtained, and wherein the display area of the input picture of the sub-channel is covered on the input picture of the main channel at a display position corresponding to the position parameter.

6. The method according to claim 5, further comprising:
adjusting the display position of the display area of the input picture of the sub-channel on the input picture of the main-channel before composing the display area of the input picture of the sub-channel and the input picture of the main channel into the single composed picture.

7. A method for multi-picture display, the method comprising:
determining one channel as a first sub-channel and another channel as a second sub-channel;
receiving an input picture of the first sub-channel and an input picture of the second sub-channel;
selecting a display area of the input picture of the first sub-channel and a display area of the input picture of the second sub-channel;
determining the display areas of the input pictures of the first and second sub-channels; and
composing the display areas of the input pictures of the first and second sub-channels into one single picture with the display areas of the input pictures of the first and second sub-channels arranged side by side.

8. The method according to claim 7, wherein each of the display areas of the input pictures in the single composed picture retains an original resolution so that respective interest areas of the input pictures of the first and second sub-channels are seen clearly at the same time.

9. The method according to claim 7, wherein further comprising:
displaying the composed single picture on a display screen.

10. The method according to claim 7, wherein the display area of the input picture of each playing sub-channel is a partial area of the input picture of the playing sub-channel.

11. The method according to claim 7, wherein when the selecting the display area of the input picture of the first playing sub-channel and the display area of the input picture of the second playing sub-channel is performed, a position parameter of the selected display areas of the input pictures of each playing sub-channels is obtained, and wherein the display area of the input picture of each playing sub-channel is arranged on the composed single picture at a display position corresponding to the position parameter.

12. The method according to claim 11, further comprising:
adjusting the display position of the display area of the input picture of each playing sub-channel on the composed single picture before the composing the display areas of the input pictures of the first and second playing sub-channels into one single picture.

13. A system for multi-picture display, the system comprising:
a tuner unit configured for determining a plurality of channels and receiving an input picture from each of the channels;
a display area setting unit configured for selecting a display area of the input picture from each of determined channels;
an image processing unit configured for determining the display areas of the input pictures of all the determined channels and composing display areas of the input pictures of all the determined channels into one single composed picture.

14. The system according to claim 13, further comprising:
a display unit configured for displaying the composed single picture.

15. The system according to claim 13, further comprising:
a display position setting unit configured for adjusting a display position of the display area of the input picture of each determined channel on the composed single picture.

16. The system according to claim 13, wherein one of the determined channels is regarded as a playing main-channel and the other determined channels are regarded as playing sub-channel, and wherein
the display area of the input picture of each playing sub-channel is a partial area of the input picture of the playing sub-channel, and the display area of the input picture of the playing main-channel is a whole picture of the playing main-channel.
